(19) United States
(12) Patent Application Publication
(10) Pub. No.: US 2021/0062639 A1
(43) Pub. Date: Mar. 4, 2021

(54) PULSED POWER SCULPTING METHODS

(71) Applicant: Halliburton Energy Services, Inc., Houston, TX (US)

(72) Inventors: Dale E. Jamison, Humble, TX (US); William Walter Shumway, Spring, TX (US)

(21) Appl. No.: 16/559,539

(22) Filed: Sep. 3, 2019

(51) Int. Cl. E21B 47/01; E21B 17/10

(52) U.S. Cl. CPC E21B 47/01; E21B 17/1021

(57) ABSTRACT

Methods of sculpting a hard material. An example method includes providing a pulsed power apparatus comprising: an articulated arm; a pulsed power drill bit comprising two electrodes and coupled to the articulated arm; and a power generator coupled to the two electrodes. The method further includes positioning the pulsed power drill bit such that at least one of the electrodes contacts the hard material; submerging the electrodes in a dielectric fluid; and discharging a high voltage pulse from at least one of the electrodes such that the discharged high voltage pulse passes through the hard material.

### TECHNICAL FIELD

The present disclosure relates generally to sculpting with pulsed power methods, and more particularly, to sculpting stone, cement, concrete and other hard materials with the application of pulsed power methods.

### BACKGROUND

The removal and sculpting of hard materials is an important part of a variety of applications. For example, the repair and resurfacing of road surfaces frequently requires the removal and/or shaping of existing asphalt or concrete surfaces before the new road materials can be applied to level and fill-in the variations in the road surface. As another example, cuts of various shapes and depths may be made in hard materials such as concrete to provide locations for joints, posts, or other interlocking structures for building and design applications. The shape of these cuts may be simple circular cuts or more complex cuts designed to lock in the inserted structure preventing its relative movement. As still yet another example, hard materials may be sculpted into various aesthetic designs such as sculptures, fountains, chairs, tables, stairs, and the like. These features may be chiseled into the hard material surface using abrasive cutting elements in a delicate and time consuming process.

The removal and sculpting of hard materials may be an arduous process. Typically, abrasive cutting elements such as drill bits, chisels, and the like are used to physically apply force and cut or grind away sections of the hard material. These techniques can take a significant amount of time, especially when a large section of the hard material requires removal. Moreover, these methods can be expensive as the cutting elements are worn down with each use. This can result in shortened useful lives for the cutting elements. The present disclosure provides improved methods for the sculpting and removal of hard materials using pulsed power methods.

### BRIEF DESCRIPTION OF THE DRAWINGS

Illustrative examples of the present disclosure are described in detail below with reference to the attached drawing figures, which are incorporated by reference herein, and wherein:

FIG. 1 is a schematic illustrating an example pulsed power apparatus in accordance with one or more examples described herein;

FIG. 2 is a schematic illustrating an example method of use of the pulsed power apparatus of FIG. 1 in accordance with one or more examples described herein;

FIG. 3 is a schematic illustrating an example pulsed power apparatus used to etch a shape in a hard material in accordance with one or more examples described herein;

FIG. 4A is a schematic illustrating shapes that may be cut with a pulsed power apparatus to interlock with one another in accordance with one or more examples described herein;

FIG. 4B is a schematic illustrating the shapes of 4A after they have been interlocked in accordance with one or more examples described herein;

FIG. 5 is an isometric perspective of an example pulsed power apparatus used to sculpt a bust from a hard material in accordance with one or more examples described herein;

FIG. 6 is an isometric perspective of an example pulsed power apparatus mounted to a vehicle for sculpting a tunnel in a hard material in accordance with one or more examples described herein; and

FIG. 7 is an isometric perspective of an example pulsed power apparatus mounted to a vehicle for fixing a road surface in accordance with one or more examples described herein.

The illustrated figures are only exemplary and are not intended to assert or imply any limitation with regard to the environment, architecture, design, or process in which different examples may be implemented.

### DETAILED DESCRIPTION

The present disclosure relates generally to sculpting with pulsed power methods, and more particularly, to sculpting stone, cement, concrete, and other hard materials with the application of pulsed power methods.

In the following detailed description of several illustrative examples, reference is made to the accompanying drawings that form a part hereof, and in which is shown by way of illustration examples that may be practiced. These examples are described in sufficient detail to enable those skilled in the art to practice them, and it is to be understood that other examples may be utilized and that logical structural, mechanical, electrical, and chemical changes may be made without departing from the spirit or scope of the disclosed examples. To avoid detail not necessary to enable those skilled in the art to practice the examples described herein, the description may omit certain information known to those skilled in the art. The following detailed description is, therefore, not to be taken in a limiting sense, and the scope of the illustrative examples are defined only by the appended claims.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the examples of the present disclosure. At the very least, and not as an attempt to limit the application of the doctrine of equivalents to the scope of the claim, each numerical parameter should at least be construed in light of the number of reported significant digits and by applying ordinary rounding techniques. It should be noted that when “about” is at the beginning of a numerical list, “about” modifies each number of the numerical list. Further, in some numerical listings of ranges some lower limits listed may be greater than some upper limits listed. One skilled in the art will recognize that the selected subset will require the selection of an upper limit in excess of the selected lower limit.

Unless otherwise specified, any use of any form of the terms “connect,” “engage,” “couple,” “attach,” or any other term describing an interaction between elements is not meant to limit the interaction to direct interaction between the elements and may also include indirect interaction between the elements described. Further, any use of any form of the terms “connect,” “engage,” “couple,” “attach,” or any other term describing an interaction between elements includes items integrally formed together without the aid of extraneous fasteners or joining devices. In the following discussion and in the claims, the terms “including” and “comprising” are used in an open-ended fashion, and thus should be interpreted to mean “including, but not limited to.” Unless otherwise indicated, as used throughout this document, “or” does not require mutual exclusivity.

The terms uphole and downhole may be used to refer to the location of various components relative to the bottom or end of a well. For example, a first component described as uphole from a second component may be further away from the end of the well than the second component. Similarly, a first component described as being downhole from a second component may be located closer to the end of the well than the second component.

The examples described herein relate to the use of an apparatus/method for the pulsed power sculpting and removal of hard materials. The apparatus/method may be used to quickly and efficiently remove targeted sections of hard material by transmitting plasma through the hard material at a desired location and target depth. The plasma crushes and dislodges the hard material in its path. Advantageously, the amount of hard material to be removed may be controlled through the positioning of the pulsed power bit and the arrangement of the electrodes as they contact the surface of the hard material. As a further advantage, the intensity of the pulsed high voltage discharge may be adjusted to provide additional control of the amount of material anticipated to be removed. As a still further advantage, the degree of material removal for a specific voltage may be estimated by modeling produced from the analysis of previously collected records and data. This modeling allows for the estimation of the amount of power needed for a desired amount of material removal for a specific material. As an additional benefit, this modeling may be further enhanced with the application of artificial intelligence and machine learning to provide real-time estimates as to the amount of power needed to provide a desired amount of material removal to achieve a targeted cut or shape in the hard material. These same estimation techniques may also be applied to positioning the pulsed power bit and arranging the electrodes to optimize the material removal. As an additional advantage, the dielectric fluids used for the pulsed power methods may be fluids typically not usable in drilling applications. Examples of these dielectric fluids are those that are unable to carry cuttings, are not suitable for contact with aqueous fluids, and/or are not suitable for high temperature environments. The use of these species of dielectric fluids may greatly simplify the system and may reduce overall costs. A still further advantage is that apparatus/method may be used to sculpt and remove hard materials generally faster than techniques using abrasive cutting elements such as drill bits, chisels, and the like. Another advantage is that the apparatus/method may have a greater useful life than techniques utilizing abrasive cutting elements as the tool may not be worn down through abrasive contact with the hard material.

The pulsed power apparatus may be used to discharge a pulsed electrical current through a hard material to cause plasma to pass through the hard material, thereby crushing and dislodging portions of the hard material around the path of the plasma. The apparatus comprises an articulated bit that is able to be moved and rotated in three dimensions, as well as a sufficient power generator coupled to the bit via an electrical conduit. The power generator is configured to deliver the high voltage pulses. The power generator is coupled to and powered by a sufficient power source. The bit further comprises at least two electrodes having an electrode gap therebetween. The electrodes are positionable on the bit to increase or decrease the length of the electrode gap as well as to position the electrodes to enable the desired contact with the surface of the hard material. At least one of the electrodes should be positioned to contact the hard material. The other electrode should be positioned at a sufficient location and proximity to the contacting electrode to allow for the discharged electric current to contact and pass through the hard material.

The pulsed power apparatus may use any hard material as a substrate. Examples of hard materials may include, but are not limited to, cement; concrete; any mineral material such as sandstone, limestone, volcanic rock, granite, onyx, quartz, etc.; ceramics; hardened clays; glass; plastics; wood; composite materials; and any combination thereof.

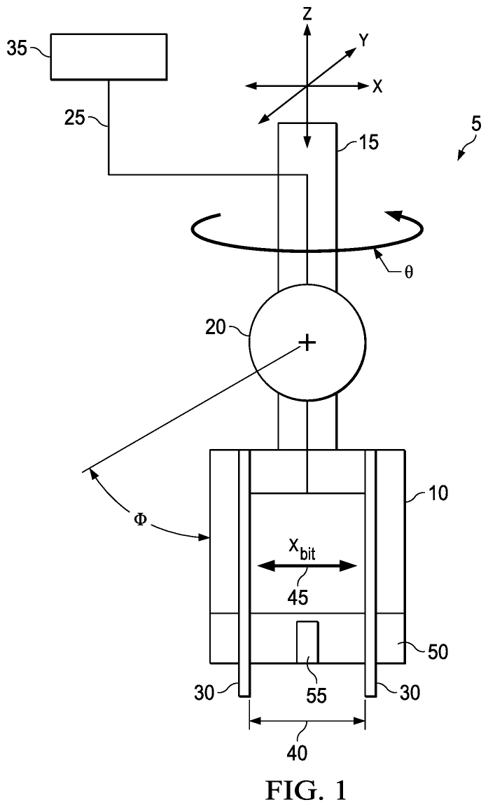

FIG. 1 illustrates a schematic of an example pulsed power apparatus, generally 5. The pulsed power apparatus 5 comprises a bit 10 coupled to and disposed at the terminal end of an articulated arm 15. Articulated arm 15 is able to rotate 360°, or at an angle sufficiently close to 360°. The articulated arm 15 also comprises at least one joint 20. The joint 20 allows for the bit 10 to be pivoted upward and to the side in the illustrated z plane. The joint 20 may be selected to provide an angle of movement as large as desired. In some examples, the articulated arm 15 may comprise a multiple of joints 20 potentially allowing for a greater degree of movement of the bit 10. In some further examples, the joint 20 may be rotatable in the illustrated x and y planes.

The articulated arm 15 further comprises an electrical conduit 25 that may transmit power from a power generator 35 to the electrodes 30 at the end of the bit 10. The electrical conduit 25 may be disposed internally or externally on the articulated arm 15. The power generator 35 may be an attached component of the pulsed power apparatus 5 or a detached component of the pulsed power apparatus 5 that is only coupled to the pulsed power apparatus 5 via the electrical conduit 25. The power generator 35 is sufficient to generate a sufficient high voltage pulse sufficient for crushing and dislodging a portion of a hard material. The voltage may be adjustable so as to allow for control over the amount of material that is crushed and dislodged from the electrical discharge. Generally, a high voltage pulse of approximately 100 kV is sufficient for most hard materials, although the voltage may increased or decreased depending upon the type of hard material and volume of material to be removed. The power generator 35 is further coupled to a power source (not illustrated) which may be a component of the power generator 35 or a separate component.

The bit 10 comprises at least two electrodes 30 having an electrode gap 40 disposed therebetween. The illustrated set of two electrodes 30 comprises a high voltage or hot electrode and a ground electrode configured to create an arc of discharged electricity or plasma between them in the electrode gap 40. The bit 10 may comprise more than two electrodes 30 and may include multiples of high voltage electrodes and/or ground electrodes as desired. In examples in which the number of electrodes 30 is greater than two, multiple electrode gaps 40 may also be present between the pairs or sets of electrodes. The electrodes 30 may discharge the electrical current produced from the power generator 35 into a hard material disposed proximate to the electrode gap 40. The electrode gap 40 may be increased or decreased in length by movement of the electrodes 30 in the directions indicated by arrow 45 to lengthen or narrow the electrode gap 40 as desired. Moreover, in some optional examples, the head portion 50 or face of the bit 10 may be rotatable to position the electrodes 30 in a desired orientation. In some further optional examples, the electrodes 30 may be compressible and have a default outward bias. In these examples, the electrodes 30 may compress or retract slightly inward into the bit 10 when contacting the surface of the hard material. The outward biasing of the electrodes 30 maintains contact of the electrodes 30 against the hard material so long as sufficient force is applied.

The rotational and angular movement of the articulated arm 15 and joint 20 coupled with the moveable and positionable electrodes 30 provides the pulsed power apparatus 5 with the ability to position itself over a desired area of a hard material and to pass current through the desired area of hard material. The power generator 35 is tunable such that it discharges a pulsed high voltage current through a desired volume of the hard material. This combination of features allows the pulsed power apparatus 5 to carefully remove portions of a hard material sufficient to sculpt said hard material as desired.

The head portion 50 of the bit 10 comprises a channel to release a dielectric fluid for the bit 10. A sufficient amount of dielectric fluid may be released to cover the target surface of the hard material and to submerge the electrodes 30 contacting said target surface. The dielectric fluid is a nonconductive fluid with a dielectric constant higher than that of the hard material. The nonconductive dielectric fluid does not conduct electricity and the dielectric fluid may quench an electric discharge. Generally, the dielectric fluid should possess a dielectric strength of around 300 kV/cm or more and a dielectric constant of about 6 to about 12. The dielectric fluid may be a drilling fluid suitable for pulsed power drilling or may be a fluid not suitable for pulsed power drilling. Examples of dielectric fluids useful for pulsed power drilling include those having a sufficient viscosity to remove cutting through an annulus as well as those fluids which are stable at high temperatures and safe for contact with water. Examples of other dielectric fluids, including those not used for pulsed power drilling, include those with lower viscosities, insufficient for removing cuttings, as well as those that are not stable at high temperatures and those that are toxic. Cuttings of the hard material may be removed through screens or settled out. Examples of the dielectric fluid include, but are not limited to, low conductivity oil external emulsions having a high dielectric constant internal phase. Suitable oils include, but are not limited to, diesel, mineral oil, paraffin, synthetic, vegetable, castor, silicone, fluorinated, or any combination thereof. The internal phases may include, but are not limited to, aqueous fluids with a sufficiently high dielectric constant, simple alcohols, diols, polyols, and water soluble amines. Additionally, oil soluble dielectric boosters may be used. These boosters may be added to the suitable oils described above without the emulsion internal phase, or may be added to the emulsified fluid. The dielectric boosters may include, but are not limited to, organic carbonates such as butylene, propylene carbonate, etc.; highly polarizable organics such as phenol, aniline, ethyl acetate, tetrahydrofuran; or any combinations thereof. The dielectric fluid may be used in a bath, circulated, or pumped continually around the electrodes.

With continued reference to FIG. 1, the bit 10 may also comprise sensors 55. Sensors 55 may be used for a variety of purposes including providing verification that at least one of the electrodes 30 is in a desired position and is in contact with the surface of a hard material. Examples of sensors 55 include, but are not limited to, optical, ultrasonic, capacitance, touch, echo, and any combination thereof.

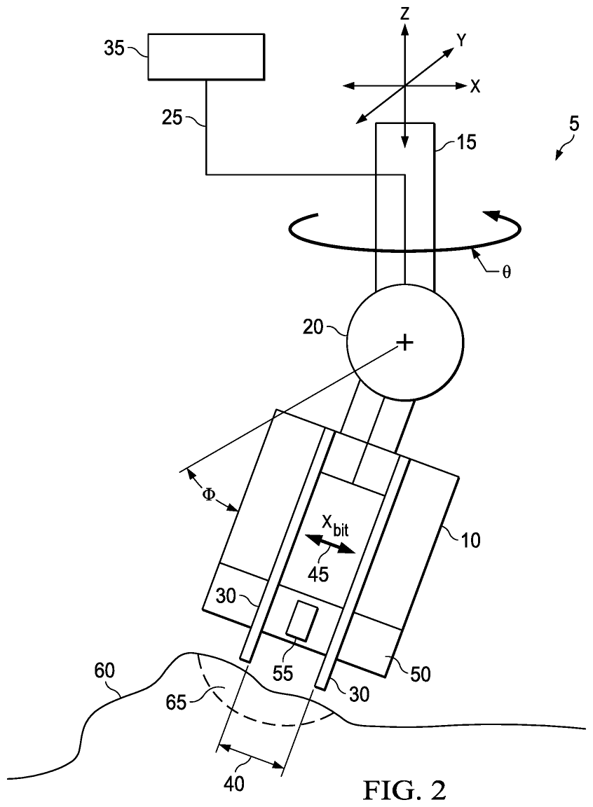

FIG. 2 illustrates a schematic of the example pulsed power apparatus 5 of FIG. 1 as used to sculpt a piece of hard material 60. The pulsed power apparatus 5 may be placed over a surface of the hard material 60 after a location for sculpting of the hard material 60 is determined. A portion 65 of the hard material 60 is illustrated as the volume of the hard material 60 enclosed within the dashed line. In the example illustrated by FIG. 2, it is desired for this portion 65 to be removed from the remainder of the hard material 60 so as to sculpt the surface of the hard material 60.

To remove the portion 65 of the hard material 60, the bit 10 of the pulsed power apparatus 5 is positioned proximate to said portion 65 at a position and angle such that at least one electrode 30 is able to contact the surface of the portion 65 while also allowing for the remaining electrode 30 to be positioned such that the discharged high voltage pulse is passed through the portion 65. To aid positioning of the electrodes 30, the joint 20 of the articulated arm 15 may be pivoted as illustrated. Further, the articulated arm 15 may be rotated to allow for movement in the x and y planes as illustrated. Moreover, in some optional examples, the bit 10 and/or the head 50 of the bit 10 may be rotated to position the electrodes 30 as desired. Lastly, the spacing between the electrodes 30 may be increased or decreased as desired to lengthen or narrow the electrode gap 40. For example, the electrode gap 40 has been narrowed in FIG. 2 as compared with FIG. 1. It is to be understood that although only two electrodes 30 are illustrated, more than two electrodes 30 may be used in some examples.

When the electrodes 30 are in the desired position and correct orientation, at least one of the electrodes 30 may be pressed against the surface of the portion 65 to contact said surface. In some optional examples, the electrodes 30 are compressible and retract slightly inward into the bit 10 when contacting the surface of the portion 65. The outward biasing of the electrodes 30 maintains contact of the electrodes 30 against the surface so long as sufficient force is applied. The sensors 55 may be used to verify and convey to an operator that contact with the surface by the electrodes 30 has been made. The sensors 55 may convey successful contact by light, sound, or any other such method as would be readily apparent to one of ordinary skill in the art.

The head portion 50 of the bit 10 comprises at least one channel running therethrough for the release of the dielectric fluid. The dielectric fluid is released when the electrodes 30 are in position. The electrodes 30 are submerged in the dielectric fluid prior to the discharge of the high voltage pulse.

The power generator 35 and electrical conduit 25 may be used to convey the high voltage pulse to the electrodes 30. The voltage may be adjustable so as to allow for control over the amount of material that is crushed and dislodged from the electrical discharge. Generally, a high voltage pulse of approximately 100 kV is sufficient for most hard materials, although the voltage may increased or decreased dependent upon the type of hard material and volume of material to be removed. The amount of voltage generated by power generator 35 may be estimated from data collected from previous records used to produce a catalogue or archive of the amount of power needed for a desired amount of material removal for a specific material. This data may be used to generate various models for future work done on a specific material. This modeling may be further enhanced with the application of artificial intelligence and machine learning to provide real-time estimates as to the amount of power needed to remove the portion 65 to achieve the targeted cut or shape in the hard material 60.

The power generator 35 may continue to provide high voltage pulses until the portion 65 is removed and the hard material 60 is shaped as desired. Cuttings from the hard material 60 may be removed by screens or simply settled out of the dielectric fluid as the operation continues. After the portion 65 is successfully removed, the bit 10 may be repositioned as described above to continue to sculpt the hard material 60 as desired.

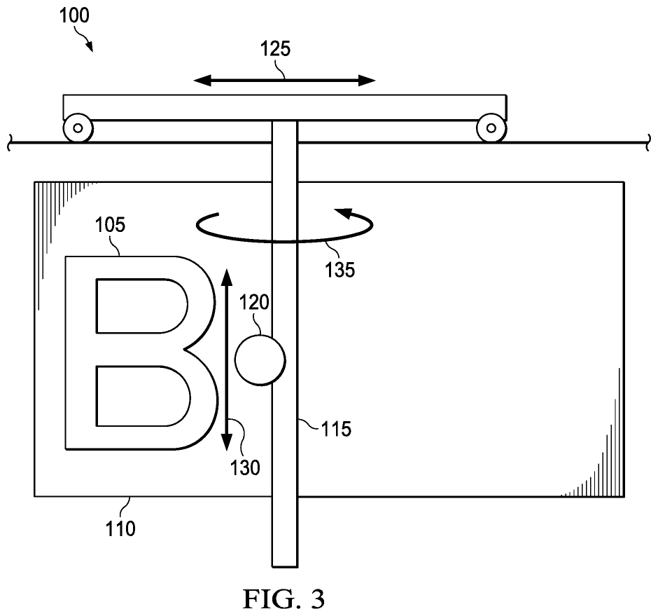

Referring now to FIG. 3, FIG. 3 is a schematic illustrating an example pulsed power apparatus 100 used to etch a shape 105 in a hard material 110. An articulated arm 115 or other such apparatus may be used to position a bit 120 over a desired location in the hard material 110. The articulated arm 115 may allow the bit 120 to travel along the x-axis 125, y-axis 130, and z-axis 135. The bit 120 is thus moveable to etch the illustrated shape 105 in the hard material 110. The electrodes of the pulsed power apparatus 100 (e.g., electrodes 30 as illustrated in FIGS. 1 and 2) may be adjusted relative to one another to increase or decrease the length of the electrode gap (e.g., electrode gap 40 as illustrated in FIGS. 1 and 2). Adjusting the length of the electrode gap allows further fine-tuning of the volume of material to be removed from the hard material 110. The amount of voltage generated by a power generator (e.g., power generator 35 as illustrated in FIGS. 1 and 2) may also be used to provide fine control of the volume of material removed. A dielectric fluid may be continuously circulated through and/or around the bit 120 for cooling and proper control of the plasma arc.

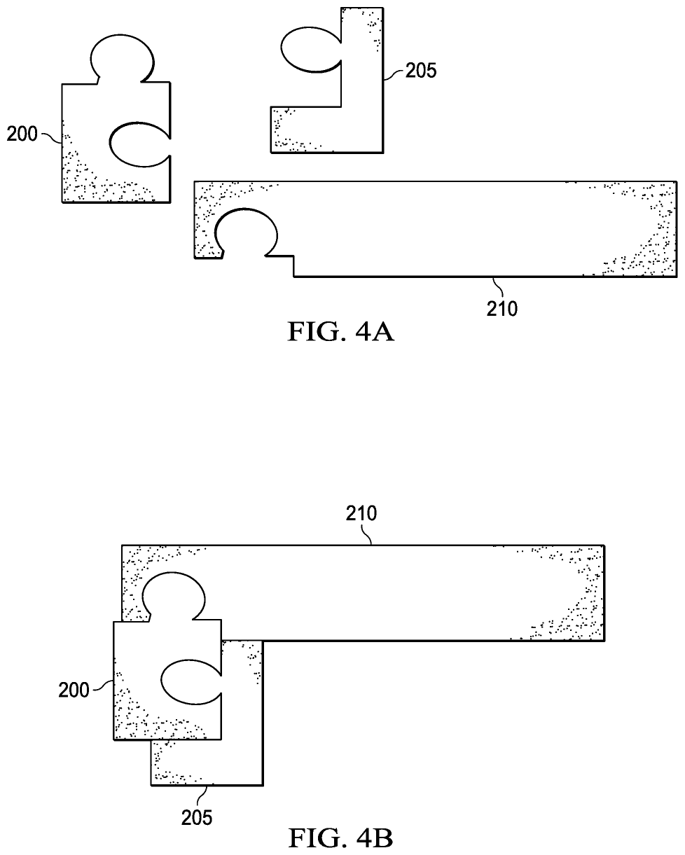

FIGS. 4A and 4B are schematics illustrating the formation of interlocking machined shapes. Shapes 200, 205, and 210 may be carved and sculpted out of a larger piece of hard material such as granite, concrete, and the like. A pulsed power apparatus (e.g., pulsed power apparatus 5 as illustrated in FIGS. 1 and 2) may be used to carve and sculpt the individual shapes 200, 205, and 210 as they appear in FIG. 4A. These shapes 200, 205, and 210 may be sculpted to exact dimensions such that they are able to interlock as illustrated in FIG. 4B. The interlocked shapes 200, 205, and 210 may be held together in the illustrated tied block without the need for cement or any type of adhesive. The sculpting of interlocking shapes may be important for applications such as cutting grooves into concrete walls for locking retaining walls into road beds. FIGS. 4A and 4B illustrate the sculpting and formation of a few examples of interlocking shapes, and it is to be understood that the pulsed power apparatus and methods disclosed herein may sculpt a variety of interlocking shapes for a multitude of applications.

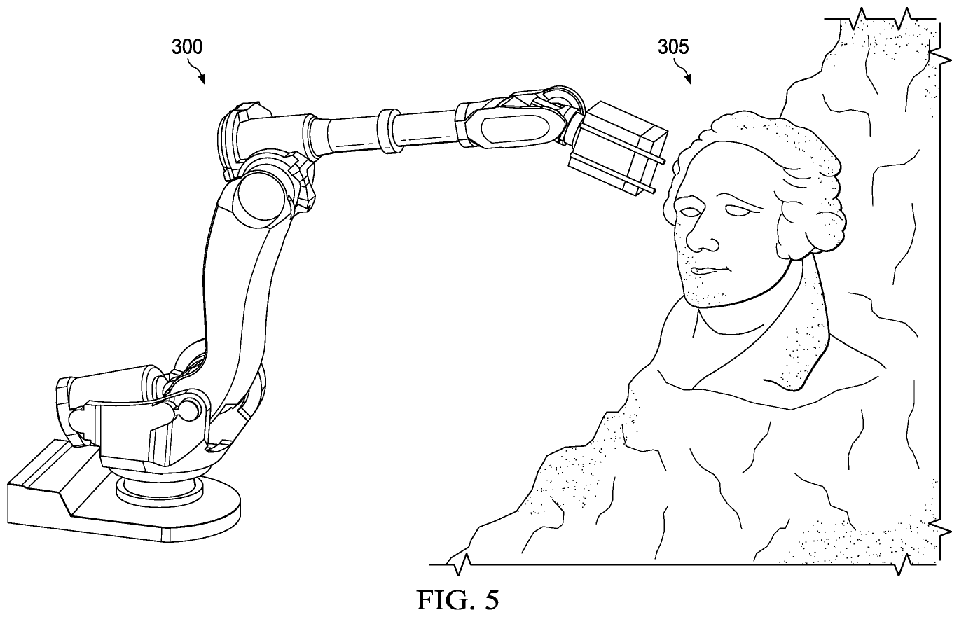

FIG. 5 is an isometric perspective of an example pulsed power apparatus, generally 300, for mounting to a table or another tool or for placement in a fabrication hub such as an assembly line or factory floor. The pulsed power apparatus 300 may be used to sculpt a bust, generally 305, out of a larger piece of hard material as illustrated.

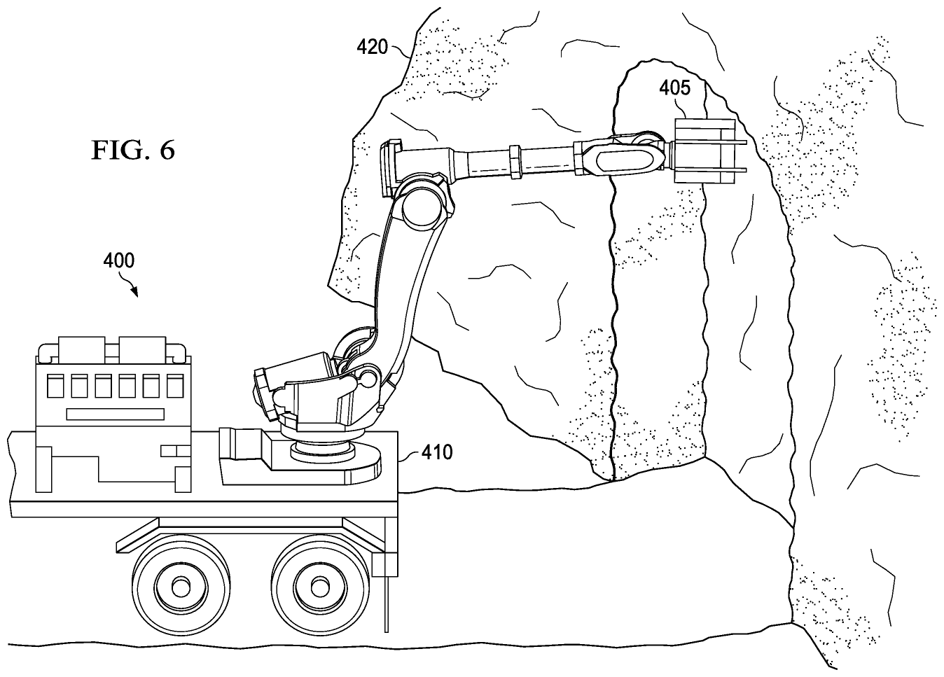

FIG. 6 is an isometric perspective of an example system, generally 400, comprising a pulsed power apparatus, generally 405, that is mounted to a vehicle 410. Vehicle 410 allows for the pulsed power apparatus 405 to be easily transportable for operations such as road tunneling. The pulsed power apparatus 405 may also be transported and readily usable in remote locations where transport of other tunneling equipment may be difficult. In some examples, the vehicle 410 may house the power generator (e.g., power generator 35 as illustrated in FIGS. 1 and 2) for the pulsed power apparatus 405. The pulsed power apparatus 405 may be used to carve a tunnel in a hard material, such as the rock formation 420, as illustrated. Although the vehicle 410 is illustrated as a truck, it is to be understood that in other examples vehicle 410 may be replaced with a car, trailer, train, ATV, watercraft, and more generally, any transporting vehicle of sufficient size to transport the pulsed power apparatus 405.

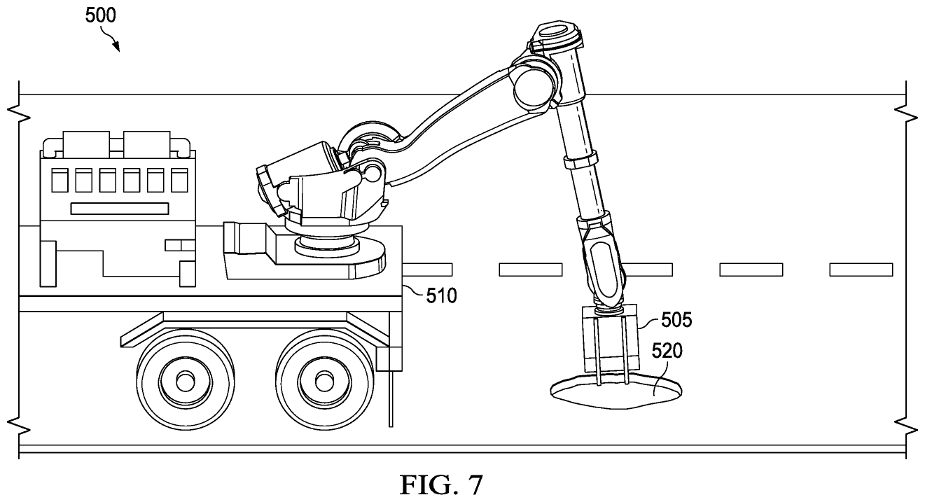

FIG. 7 is an isometric perspective of an example system, generally 500, comprising a pulsed power apparatus, generally 505, mounted to a vehicle 510. Vehicle 510 may be a truck used in road repair applications. In some examples, the vehicle 510 may house the power generator (e.g., power generator 35 as illustrated in FIGS. 1 and 2) for the pulsed power apparatus 505. The pulsed power apparatus 505 may be used to prepare a road surface 520 for repair by leveling the road surface and/or by placing grooves or other formations for locking road materials into the road surface 520. Although the vehicle 510 is illustrated as a truck, it is to be understood that other types of road repair vehicles may be utilized in other examples.

It should be clearly understood that the examples illustrated by FIGS. 1-7 are merely a few general applications of the principles of this disclosure in practice, and a wide variety of other examples are possible. Therefore, the scope of this disclosure is not limited in any manner to the details of FIGS. 1-7 as described herein.

It is also to be recognized that the disclosed pulsed power apparatus 505 may also directly or indirectly affect the various downhole equipment and tools that may contact the pulsed power apparatus 505 disclosed herein. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the methods and systems generally described above and depicted in FIGS. 1-7.

Provided are methods of sculpting a hard material in accordance with the disclosure and the illustrated FIGs. An example method comprises providing a pulsed power apparatus comprising: an articulated arm; a pulsed power drill bit comprising two electrodes and coupled to the articulated arm; and a power generator coupled to the two electrodes. The method further comprises positioning the pulsed power drill bit such that at least one of the electrodes contacts the hard material; submerging the electrodes in a dielectric fluid; and discharging a high voltage pulse from at least one of the electrodes such that the discharged high voltage pulse passes through the hard material.

Additionally or alternatively, the method may include one or more of the following features individually or in combination. The hard material may be selected from the group consisting of cement, concrete, stone, a ceramic, a hardened clay, glass, a plastic, wood, a composite material thereof, and any combination thereof. The method may further comprise sculpting the hard material into at least two shapes capable of interlocking with one another. The hard material may be a road or a part of a road. The pulsed power apparatus may be mounted onto a vehicle and wherein the high voltage pulse is discharged while the pulsed power apparatus is mounted onto the vehicle. The pulsed power drill bit may further comprise an electrode gap disposed between the two electrodes, and wherein the method further comprises moving the electrodes to adjust the length of the electrode gap. The method may further comprise adjusting the volume of the hard material the discharged high voltage pulse passes through by adjusting the voltage of the high voltage pulse produced by the power generator. The method may further comprise estimating the voltage of the high voltage pulse using data collected from previous pulsed power sculpting of the same type of hard material. The dielectric fluid may comprise a diesel oil, a mineral oil, a paraffin, a synthetic oil, a vegetable oil, a castor oil, a silicone oil, a fluorinated oil, an aqueous fluid, a simple alcohol, a diol, a polyol, a water soluble amine, or any combination thereof. The dielectric fluid may comprise a dielectric booster of an organic carbonate, a highly polarizable organic, or a combination of the two. The articulated arm may be rotatable and further comprise a joint configured to move the pulsed power drill bit. The joint may be rotatable. The pulsed power drill bit may be rotatable. The pulsed power drill bit may further comprise an electrode gap disposed between the two electrodes, and the electrodes are moveable so as to adjust the length of the electrode gap. The pulsed power apparatus may further comprise a sensor configured to determine when at least one of the electrodes is in contact with a hard material.

Provided is a pulsed power apparatus in accordance with the disclosure and the illustrated FIGs. An example pulsed power apparatus comprises an articulated arm; a pulsed power drill bit comprising two electrodes and coupled to the articulated arm; and a power generator coupled to the two electrodes.

Additionally or alternatively, the pulsed power apparatus may include one or more of the following features individually or in combination. The articulated arm may be rotatable and further comprise a joint configured to move the pulsed power drill bit. The joint may be rotatable. The pulsed power drill bit may be rotatable. The pulsed power drill bit may further comprise an electrode gap disposed between the two electrodes, and the electrodes are moveable so as to adjust the length of the electrode gap. The pulsed power apparatus may further comprise a sensor configured to determine when at least one of the electrodes is in contact with a hard material. The hard material may be selected from the group consisting of cement, concrete, stone, a ceramic, a hardened clay, glass, a plastic, wood, a composite material thereof, and any combination thereof.

Provided are systems for sculpting a hard material in accordance with the disclosure and the illustrated FIGs. An example system comprises a pulsed power apparatus comprising: an articulated arm; a pulsed power drill bit comprising two electrodes and coupled to the articulated arm; and a power generator coupled to the two electrodes. The system further comprises a vehicle onto which the articulated arm and the pulsed power drill bit are mounted.

Additionally or alternatively, the system may include one or more of the following features individually or in combination. The vehicle may be a road surface repair vehicle. The power generator may be mounted to the vehicle. The articulated arm may be rotatable and further comprise a joint configured to move the pulsed power drill bit. The joint may be rotatable. The pulsed power drill bit may be rotatable. The pulsed power drill bit may further comprise an electrode gap disposed between the two electrodes, and the electrodes are moveable so as to adjust the length of the electrode gap. The pulsed power apparatus may further comprise a sensor configured to determine when at least one of the electrodes is in contact with a hard material. The hard material may be selected from the group consisting of cement, concrete, stone, a ceramic, a hardened clay, glass, a plastic, wood, a composite material thereof, and any combination thereof. The system may further comprise a dielectric fluid. The dielectric fluid may comprise a diesel oil, a mineral oil, a paraffin, a synthetic oil, a vegetable oil, a castor oil, a silicone oil, a fluorinated oil, an aqueous fluid, a simple alcohol, a diol, a polyol, a water soluble amine, or any combination thereof. The dielectric fluid may comprise a dielectric booster of an organic carbonate, a highly polarizable organic, or a combination of the two.

The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps. The systems and methods can also “consist essentially of” or “consist of the various components and steps.” Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as ranges from any lower limit may be combined with any other lower limit to recite a range not explicitly recited. In the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

One or more illustrative examples incorporating the examples disclosed herein are presented. Not all features of a physical implementation are described or shown in this application for the sake of clarity. Therefore, the disclosed systems and methods are well adapted to attain the ends and advantages mentioned, as well as those that are inherent therein. The particular examples disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown other than as described in the claims below. It is therefore evident that the particular illustrative examples disclosed above may be altered, combined, or modified, and all such variations are considered within the scope of the present disclosure. The systems and methods illustratively disclosed herein may suitably be practiced in the absence of any element that is not specifically disclosed herein and/or any optional element disclosed herein.

Although the present disclosure and its advantages have been described in detail, it should be understood that various changes, substitutions and alterations can be made herein without departing from the spirit and scope of the disclosure as defined by the following claims.

What is claimed is:

1. A method for sculpting a hard material, the method comprising:
providing a pulsed power apparatus comprising:
an articulated arm;
a pulsed power drill bit comprising two electrodes and coupled to the articulated arm; and
a power generator coupled to the two electrodes; and
positioning the pulsed power drill bit such that at least one of the electrodes contacts the hard material;
submerging the electrodes in a dielectric fluid; and
discharging a high voltage pulse from at least one of the electrodes such that the discharged high voltage pulse passes through the hard material.

2. The method of claim 1, wherein the hard material is selected from the group consisting of cement, concrete, stone, a ceramic, a hardened clay, glass, a plastic, wood, a composite material thereof, and any combination thereof.

3. The method of claim 1, further comprising sculpting the hard material into at least two shapes capable of interlocking with one another.

4. The method of claim 1, wherein the hard material is a road or a part of a road.

5. The method of claim 1, wherein the pulsed power apparatus is mounted onto a vehicle and wherein the high voltage pulse is discharged while the pulsed power apparatus is mounted onto the vehicle.

6. The method of claim 1, wherein the pulsed power drill bit further comprises an electrode gap disposed between the two electrodes, and wherein the method further comprises moving the electrodes to adjust the length of the electrode gap.

7. The method of claim 1, wherein the method further comprises adjusting the volume of the hard material the discharged high voltage pulse passes through by adjusting the voltage of the high voltage pulse produced by the power generator.

8. The method of claim 7, further comprising estimating the voltage of the high voltage pulse using data collected from previous pulsed power sculpting of the same type of hard material.

9. The method of claim 1, wherein the dielectric fluid comprises a diesel oil, a mineral oil, a paraffin, a synthetic oil, a vegetable oil, a castor oil, a silicone oil, a fluorinated oil, an aqueous fluid, a simple alcohol, a diol, a polyol, a water soluble amine, or any combination thereof.

10. The method of claim 1, wherein the dielectric fluid comprises a dielectric booster of an organic carbonate, a highly polarizable organic, or a combination of the two.

11. The method of claim 1, wherein the articulated arm is rotatable and further comprises a joint configured to move the pulsed power drill bit.

12. A pulsed power apparatus comprising:
an articulated arm;
a pulsed power drill bit comprising two electrodes and coupled to the articulated arm; and
a power generator coupled to the two electrodes.

13. The pulsed power apparatus of claim 12, wherein the articulated arm is rotatable and further comprises a joint configured to move the pulsed power drill bit.

14. The pulsed power apparatus of claim 12, wherein the joint is rotatable.

15. The pulsed power apparatus of claim 12, wherein the pulsed power drill bit is rotatable.

16. The pulsed power apparatus of claim 12, wherein the pulsed power drill bit further comprises an electrode gap disposed between the two electrodes, and wherein the electrodes are moveable so as to adjust the length of the electrode gap.

17. The pulsed power apparatus of claim 12, further comprising a sensor configured to determine when at least one of the electrodes is in contact with a hard material.

18. A system for sculpting a hard material, the system comprising:
a pulsed power apparatus comprising:
an articulated arm;
a pulsed power drill bit comprising two electrodes and coupled to the articulated arm; and
a power generator coupled to the two electrodes; and
a vehicle onto which the articulated arm and the pulsed power drill bit are mounted.

19. The system of claim 18, wherein the vehicle is a road surface repair vehicle.

20. The system of claim 18, wherein the power generator is mounted to the vehicle.
